(19) United States
(12) Patent Application Publication
(10) Pub. No.: US 2025/0074331 A1
(43) Pub. Date: Mar. 6, 2025

(54) VEHICULAR SURROUND-VIEW VISION SYSTEM WITH SINGLE CAMERA

(71) Applicant: Magna Electronics Inc., Auburn Hills, MI (US)

(72) Inventor: Ramnath Baje Shenoy, Karnataka (IN)

(21) Appl. No.: 18/820,560

(22) Filed: Aug. 30, 2024

Related U.S. Application Data
(60) Provisional application No. 63/580,720, filed on Sep. 6, 2023.

(51) Int. Cl. B60R 11/04; B60R 1/27; B60R 11/00

(52) U.S. Cl. CPC B60R 11/04; B60R 1/27; B60R 2011/004; B60R 2011/0084; B60R 2300/102; B60R 2300/607; B60R 2300/802

(57) ABSTRACT

A vehicular vision system includes a camera disposed at a vehicle with an extender platform that is movable between an extended state and a retracted state. With the extender platform in the extended state, the camera is at an extended position that is at a distance above the roof of the equipped vehicle. With the extender platform in the retracted state, the camera is at a retracted position that is closer to the roof of the equipped vehicle than when the camera is at the extended position. The camera, when in the extended position, has a field of view that encompasses the equipped vehicle and a region at least partially surrounding the equipped vehicle. The system displays, when the extender platform is in the extended state, at a display disposed within the equipped vehicle, a bird's-eye view of the equipped vehicle derived from the image data captured by the camera.

### CROSS REFERENCE TO RELATED APPLICATION

The present application claims the filing benefits of U.S. provisional application Ser. No. 63/580,720, filed Sep. 6, 2023, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular vision system includes a camera disposed at a vehicle equipped with the vehicular vision system and viewing exterior of the vehicle. The camera is operable to capture image data. The camera includes a CMOS imaging array, and the CMOS imaging array includes at least one million photosensors arranged in rows and columns. The system includes an electronic control unit (ECU) with electronic circuitry and associated software. The electronic circuitry of the ECU includes an image processor for processing image data captured by the camera. The system includes an extender platform that is movable between an extended state and a retracted state. With the extender platform in the extended state, the camera is at an extended position that is at a distance above the roof of the equipped vehicle. With the extender platform in the retracted state, the camera is at a retracted position that is closer to the roof of the equipped vehicle than when the camera is at the extended position. The camera, when in the extended position, has a field of view that encompasses the equipped vehicle and a region at least partially surrounding the equipped vehicle. The vehicular vision system, responsive to processing by the image processor of the image data captured by the camera when the extender platform is in the extended state, displays, at a display disposed within the equipped vehicle and viewable by a driver of the equipped vehicle, a bird's-eye view of the equipped vehicle derived from the image data captured by the camera.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIGS. 2 and 3 are images captured by a traditional surround view camera system;

FIG. 4 is an image of an exemplary antenna extender platform; and

FIG. 5 is a block diagram of the vision system of FIG. 1.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like.

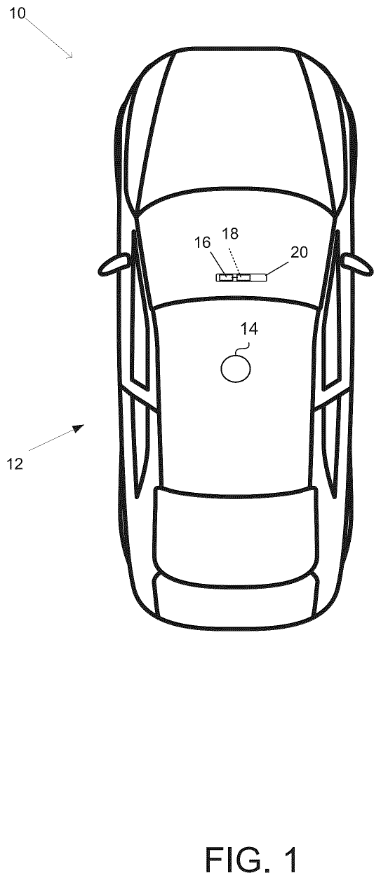

Referring now to the drawings and the illustrative embodiments depicted therein, a vehicle 10 includes an imaging system or vision system 12 that includes at least one exterior viewing imaging sensor or camera, such as a camera 14 disposed at or near a roof of the vehicle (and the system may optionally include multiple exterior viewing imaging sensors or cameras, such as a forward viewing camera at the front (or at the windshield) of the vehicle, a sideward/rearward viewing camera at respective sides of the vehicle, and a rearward viewing camera at the rear of the vehicle), which captures images exterior of the vehicle, with the camera having a lens for focusing images at or onto an imaging array or imaging plane or imager of the camera (FIG. 1). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

Many vehicles come equipped with a 360-degree surround view system, which is also referred to as a bird's-eye view car camera system or a surround view camera system. These systems are a collection of devices that work together to provide the driver a real-time view of the surroundings of the car. This view is generally projected directly onto dashboard hardware (e.g., the infotainment system). The system includes a set of input sensors (e.g., cameras and/or other proximity sensors) to gather necessary information needed for further processing.

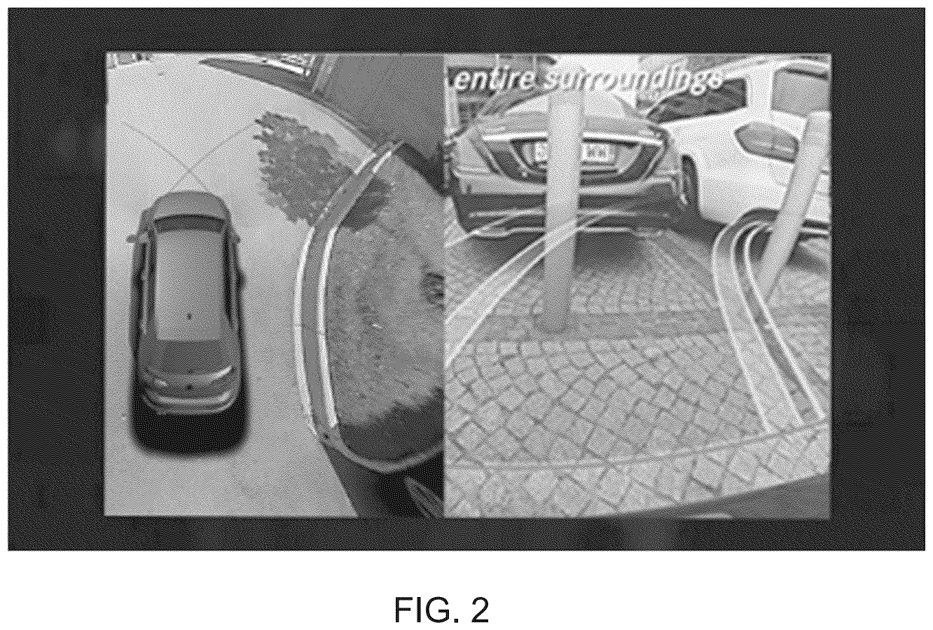

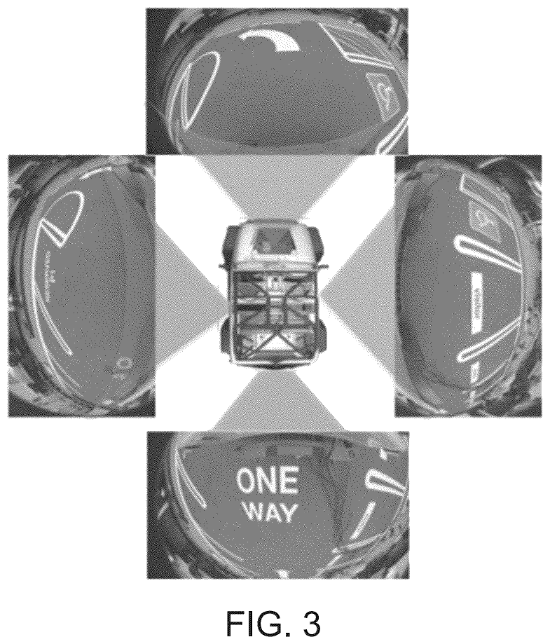

As shown in FIGS. 2 and 3, the surround view camera system software often displays the vehicle and its surroundings so that it appears to the driver like the car is being filmed by a drone from directly above the vehicle (i.e., a virtual viewpoint or bird's-eye view). The image screen may be split to display the vehicle's top view on one side of the screen and the front/rear/side view on the other (FIG. 2). In other examples, the front of the vehicle is displayed at the top of the image, the rear of the vehicle is displayed at the bottom, and the sides at each respective side of the image (FIG. 3). The system commonly includes 4 to 6 surround view cameras with wide-angle lenses that are integrated into, for example, the body panel or bumper or exterior mirrors of the vehicle. For example, the cameras may be placed at the front grille, at or under the rear-view mirrors on either side of the vehicle, and at the tailgate or rear bumper of the vehicle. Thus, the cameras are located at locations that enable the surveillance of the entire perimeter of the vehicle.’

These systems may also include one or more proximity sensors. The proximity sensors aid in determining a distance between the vehicle and nearby objects. For example, an ultrasonic/electromagnetic device transmits signals that reflect off a nearby object and the time that it takes to receive the reflections back at the device indicates the actual distance between the vehicle and the object that reflected the signal.

In contrast to the conventional multi-camera surround view system, implementations herein include a vehicular vision system that uses a single camera mounted on top of the vehicle (i.e., at or above a roof of the vehicle) that is capable by itself of capturing a birds-eye view of the vehicle together with its immediate surroundings useful during, for example, a parking maneuver or other low speed driving. A single-camera system reduces the complexity of the overall vision system. Fewer components mean there are fewer potential points of failure, which may increase the system's reliability. Additionally, manufacturing, installation, and wiring are simplified, which can lead to a reduction in production costs. Additionally, traditional multi-camera systems require the integration of multiple images and can suffer from blind spots or distorted views due to the angles at which cameras are mounted. A single, well-positioned camera can capture a continuous, unobstructed 360-degree view of the vehicle's surroundings, which can be particularly advantageous for detecting obstacles, pedestrians, and other vehicles in close proximity to the equipped vehicle. The use of a single camera may also simplify any calibration processes. Multi-camera systems generally must be meticulously calibrated to ensure the images from each camera align correctly to produce an accurate composite view. This process can be time-consuming and must be repeated if a camera is replaced or the system is otherwise disturbed (e.g., via an accident or other collision). In contrast, a single-camera system requires calibration for only one lens, which can significantly reduce the time and effort needed to maintain the system's accuracy over time.

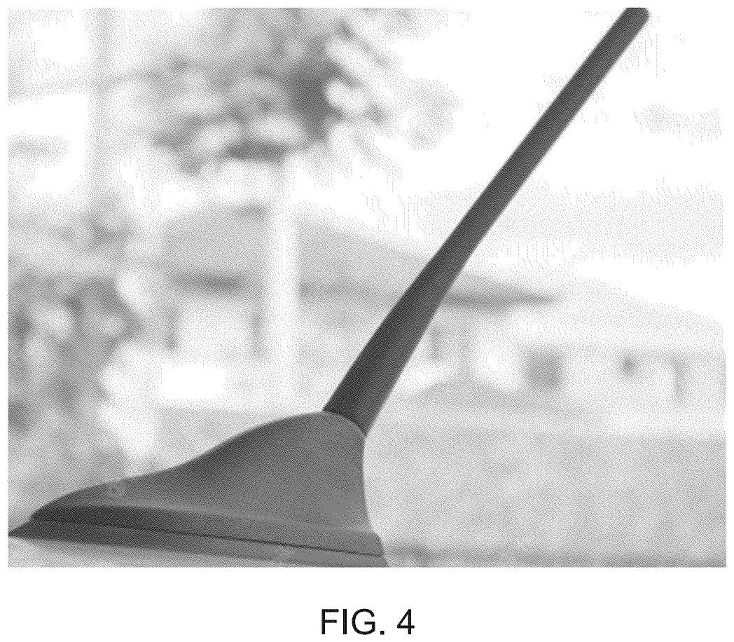

As shown in FIG. 4, the camera may be mounted on an extender platform (similar to some extendable radio antennas). The extender platform may be movable between an extended state and a retracted state. The extender platform may be by default positioned in the retracted/enclosed state which results in a portion of the extender platform and/or the camera at or near or embedded within the roof module. For example, the extender platform may be positioned in the retracted state while the vehicle is off and/or during normal driving conditions such as when driving above a threshold speed (e.g., above 5 miles per hour, above 10 miles per hour, above 20 miles per hour, etc.). While the vehicular vision system is in operation (e.g., when the driver or vehicle (during autonomous or semi-autonomous control of the vehicle) employs the surround view system, such as during low speed parking maneuvers and/or low speed reversing maneuvers), the extender platform may transition from the retracted state to the extended state by extending some distance (e.g., at least a foot, such as a few feet, such as two to four feet) above the roof to allow the downward viewing camera mounted at or near a top of the extender platform a bird's-eye view of the vehicle. Put another way, transitioning from the retracted state to the extended state moves the camera from at or near the roof of the vehicle to some distance above the roof of the vehicle. While in the extended state, the camera has a vantage point above the vehicle, and with an at least partially downward facing field of view, the camera may capture a top view image or video of the vehicle along with its surroundings/immediate vicinity.

The extender platform may have a portion that laterally extends (e.g., approximately parallel to the ground) from a central vertical extension to allow the camera to be mounted some distance from the central vertical extension of the extender platform. The camera may be mounted to the extender platform to minimize a view of the extender platform within the field of view of the camera. Optionally, the camera may be mounted such that the extender platform is within the field of view of the camera in a direction that is also imaged by an additional camera of the vehicle or in a direction deemed less important (e.g., a direction forward of the vehicle). For example, the extender platform may comprise a vertically oriented arm and a rearward extending arm that extends rearward (i.e., toward the rear of the vehicle) from an upper end of the vertically oriented arm. The camera may mount at a distal end of the rearward extending arm (distal from the vertically oriented arm) and, when the extender platform extends so that the rearward extending arm is raised above the vehicle, the camera views generally downward, whereby the field of view of the camera includes a portion of the vertically oriented arm at the forward portion of the field of view. The vertically oriented arm may extend and retract (such as via a telescoping arm or mechanism) to raise and lower the camera relative to the top of the vehicle. The rearward extending arm (or laterally extending arm) may also extend and retract from the vertically oriented arm to increase or decrease the distance between the camera and the vertically oriented arm. For example, the rearward extending arm may extend when the vertically oriented arm extends, and the rearward extending arm may retract when the vertically oriented arm retracts.

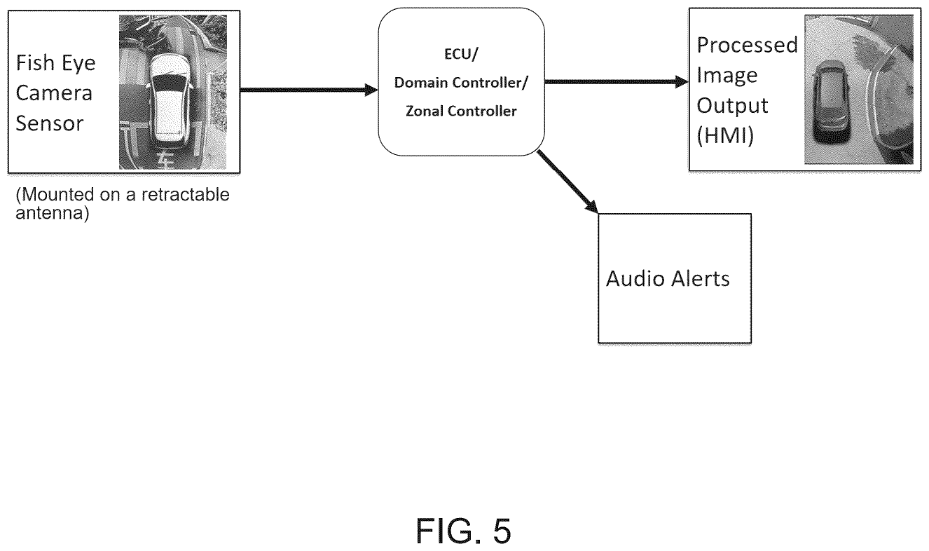

Referring now to FIG. 5, the camera may use a fisheye or other wide-angle lens to capture the surroundings of the vehicle. In some examples, an illumination source (e.g., one or more LEDs) is mounted at or near the camera to illuminate the camera's field of view in low-light conditions. Alternatively, the illuminations sources may be distributed around the perimeter of the vehicle (e.g., at the bumpers, side mirrors, etc.) to illuminate the ground and objects near the vehicle. The illumination source(s) may emit visible light or non-visible light (e.g., near infrared or infrared light). The camera may extend to different heights above the vehicle based on a user configuration (e.g., received via a user interface within the vehicle) or automatically based on the surroundings and/or environment of the vehicle. In some scenarios, the camera may extend two feet or less above the vehicle and in other scenarios the camera may extend more than two feet above the vehicle, such as four feet or more above the vehicle, in order to capture additional area around the vehicle within the field of view of the camera. For example, when the vehicle determines (e.g., via another sensor, such as an ultrasonic sensor) that an object is near the vehicle but outside the field of view of the camera, the system may automatically increase the height of the camera to ensure the object is within the field of view of the camera. The camera and/or the extender platform and/or roof of the vehicle may include one or more distance detecting sensors to ensure the camera is not extended into an object. For example, when the vehicle is within a parking garage, a distance sensor (e.g., an ultrasonic sensor or the like) may determine a height of a roof of the parking garage and ensure the camera is not extended to a height to impact the roof of the parking garage. In this example, the system may extend the camera to a lower height than usual to avoid colliding with the roof of the parking garage. In other examples, the system may prohibit the camera from extending at all when the system determines there is not sufficient (i.e., less than a threshold amount) of clearance above the vehicle. The system may generate a visual or audible alert for an occupant of the vehicle when the system lacks the proper clearance to fully extend.

Optionally, the camera may view downward with its field of view including the top of the vehicle and a region surrounding the vehicle. Optionally, the camera may view toward one side of the vehicle and may rotate about an axis while the extender platform is extended, whereby the surround view images are derived from multiple images captured by the camera as it rotates. Optionally, the camera may be adjusted or rotated to provide an enhanced view in a particular or selected direction. For example, the camera may rotate to increase or change the field of view of the camera (such as to direct the view of the camera toward an object detected by the system or in a direction the vehicle is moving). The camera may rotate to provide a panoramic view of the vehicle and the vehicle's surroundings to the display within the vehicle. The vehicular vision system may process the captured image data for display of video images derived from the processed image data. For example, the vehicular vision system may filter or mask some or all of the extender platform from the captured image data (i.e., filter portions of the extender platform that are within the field of view of the camera).

Optionally, the image data captured by the camera is provided to an image processing module which processes the image data/raw images together with its surroundings in real-time. The image processing module may be incorporated into the camera or separate from the camera (e.g., at another vehicle ECU). The processed video image data from the image processing software may be provided to an HMI (Human Machine Interface), such as an infotainment system screen, for viewing by occupants of the vehicle. One or more feedback mechanisms (e.g., visual, audio, and/or haptic alerts) may be used to notify the driver of nearby objects or other hazards. Overlays or other indicators may be included with the displayed images to warn of the presence of objects or the distance between objects and the vehicle.

Thus, from the driver's perspective, the vision system provides a bird's-eye view similar to conventional systems. However, the vision system only requires a single camera and can provide the view with less image processing and less visual distortion (which is a natural byproduct of generating a virtual viewpoint from multiple cameras). The driver or other occupant of the vehicle may enable the system via a user input such as by pushing a button. Optionally, the vision system may be automatically enabled (e.g., when the vehicle is in reverse, when the system determines the vehicle is parking, when the vehicle is below a threshold speed and within a threshold distance to another object, etc.). When the system is enabled, a motorized mechanism of the extender platform extends an antenna-like structure from the roof mount above the vehicle (e.g., over a foot above the vehicle, such as between two and four feet above the vehicle). The antenna-like structure includes a mounted camera system. This enables the camera to perceive a full top view of the vehicle together with the immediate surroundings of the vehicle. When the system is disabled, the motorized mechanism retracts such that the camera is disposed near or at or within the vehicle (e.g., within a receptacle or docking station for storage of the camera when not in use). Power and communications to/from the camera (e.g., the captured image data) travel along wires embedded within the extender platform that connects the camera to a communication bus of the vehicle.

The vision system provides a 360-surround view system of a vehicle using only a single camera extended from the roof of the vehicle. The system provides cost savings as only a single camera is required (instead of four or more cameras as used in traditional systems). Moreover, the vision system may provide lower complexity as the image data does not require extensive processing (e.g., image stitching, etc.) that multi-camera surround view systems require. Additionally, the vision system offers easy integration as the system can operate in a standalone mode or can be easily integrated with any existing advanced driver assistance system (ADAS) ECUs or standalone parking modules. Thus, the vision system eliminates the need of having complex hardware and software systems to build a surround view park assist system and the cost of the system may be greatly reduced in comparison with the similar existing systems, and can be integrated with the vehicle during the build process or sold as an aftermarket solution.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular vision system, the vehicular vision system comprising:
a camera disposed at a vehicle equipped with the vehicular vision system and viewing exterior of the vehicle, wherein the camera is operable to capture image data;
wherein the camera comprises a CMOS imaging array, and wherein the CMOS imaging array comprises at least one million photosensors arranged in rows and columns;
an electronic control unit (ECU) comprising electronic circuitry and associated software;
wherein the electronic circuitry of the ECU comprises an image processor for processing image data captured by the camera;
an extender platform that is movable between an extended state and a retracted state, wherein, with the extender platform in the extended state, the camera is at an extended position that is at a distance above the roof of the equipped vehicle, and wherein, with the extender platform in the retracted state, the camera is at a retracted position that is closer to the roof of the equipped vehicle than when the camera is at the extended position, and wherein the camera, when in the extended position, has a field of view that encompasses the equipped vehicle and a region at least partially surrounding the equipped vehicle; and
wherein the vehicular vision system, responsive to processing by the image processor of the image data captured by the camera when the extender platform is in the extended state, displays, at a display disposed within the equipped vehicle and viewable by a driver of the equipped vehicle, a bird's-eye view of the equipped vehicle derived from the image data captured by the camera.

2. The vehicular vision system of claim 1, wherein the distance is between two feet and four feet above the roof of the equipped vehicle.

3. The vehicular vision system of claim 1, wherein, when the extender platform is moved toward the retracted state, the extender platform retracts the camera to the roof of the equipped vehicle.

4. The vehicular vision system of claim 1, wherein the extender platform comprises an illumination source that is operable to illuminate at least a portion of the field of view of the camera when the extender platform is in the extended state.

5. The vehicular vision system of claim 1, wherein the extender platform transitions between the extended state and the retracted state at least partially based on a propulsion selection of the equipped vehicle.

6. The vehicular vision system of claim 5, wherein the extender platform transitions from the retracted state to the extended state when the equipped vehicle is in reverse propulsion.

7. The vehicular vision system of claim 1, wherein the extender platform transitions between the extended state and the retracted state at least partially based on a velocity of the equipped vehicle.

8. The vehicular vision system of claim 1, wherein the extender platform transitions between the extended state and the retracted state at least partially based on a user input provided by an occupant of the vehicle.

9. The vehicular vision system of claim 1, wherein the extender platform transitions between the retracted state and the extended state at least partially based on a determination that the vehicle is parking.

10. The vehicular vision system of claim 1, wherein the vehicular vision system, responsive to processing by the image processor of the image data captured by the camera when the extender platform is in the extended state, determines an object is within a threshold distance of the equipped vehicle, and wherein the vehicular vision system, responsive to determining that the object is within the threshold distance of the equipped vehicle, generates an alert for the driver of the equipped vehicle.

11. The vehicular vision system of claim 10, wherein the alert comprises an audible alert.

12. The vehicular vision system of claim 1, wherein the camera comprises a fisheye lens.

13. The vehicular vision system of claim 1, wherein when the camera is at the extended position, the camera is laterally extended from the extender platform.

14. The vehicular vision system of claim 13, wherein the camera is laterally extended toward a rear of the vehicle.

15. The vehicular vision system of claim 13, wherein the extender platform comprises (i) a vertically oriented arm and (ii) a rearward extending arm, and wherein the camera is disposed at a distal end of the rearward extending arm.

16. The vehicular vision system of claim 1, wherein the extender platform transitions between the retracted state and the extended state at least partially based on a determination that there is at least a threshold amount of clearance above the vehicle.

17. A vehicular vision system, the vehicular vision system comprising:
a camera disposed at a vehicle equipped with the vehicular vision system and viewing exterior of the vehicle, wherein the camera is operable to capture image data;
wherein the camera comprises a CMOS imaging array, and wherein the CMOS imaging array comprises at least one million photosensors arranged in rows and columns;
an electronic control unit (ECU) comprising electronic circuitry and associated software;
wherein the electronic circuitry of the ECU comprises an image processor for processing image data captured by the camera;
an extender platform that is movable between an extended state and a retracted state, wherein, with the extender platform in the extended state, the camera is at an extended position that is at a distance above the roof of the equipped vehicle, and wherein, with the extender platform in the retracted state, the camera is at a retracted position that is closer to the roof of the equipped vehicle than when the camera is at the extended position, and wherein the camera, when in the extended position, has a field of view that encompasses the equipped vehicle and a region at least partially surrounding the equipped vehicle;
wherein the vehicular vision system, responsive to processing by the image processor of the image data captured by the camera when the extender platform is in the extended state, displays, at a display disposed within the equipped vehicle and viewable by a driver of the equipped vehicle, a bird's-eye view of the equipped vehicle derived from the image data captured by the camera; and
wherein the extender platform transitions between the extended state and the retracted state at least partially based on (i) a propulsion selection of the equipped vehicle and (ii) a velocity of the equipped vehicle.

18. The vehicular vision system of claim 17, wherein, when the extender platform is moved toward the retracted state, the extender platform retracts the camera to the roof of the equipped vehicle.

19. The vehicular vision system of claim 17, wherein the extender platform comprises an illumination source that is operable to illuminate at least a portion of the field of view of the camera when the extender platform is in the extended state.

20. The vehicular vision system of claim 17, wherein the extender platform transitions from the retracted state to the extended state when the equipped vehicle is in reverse propulsion.

21. The vehicular vision system of claim 17, wherein the extender platform transitions between the extended state and the retracted state at least partially based on a user input provided by an occupant of the vehicle.

22. A vehicular vision system, the vehicular vision system comprising:
a camera disposed at a vehicle equipped with the vehicular vision system and viewing exterior of the vehicle, wherein the camera is operable to capture image data;
wherein the camera comprises a CMOS imaging array, and wherein the CMOS imaging array comprises at least one million photosensors arranged in rows and columns;
wherein the camera comprises a fisheye lens;
an electronic control unit (ECU) comprising electronic circuitry and associated software;
wherein the electronic circuitry of the ECU comprises an image processor for processing image data captured by the camera;
an extender platform that is movable between an extended state and a retracted state, wherein, with the extender platform in the extended state, the camera is at an extended position that is at a distance above the roof of the equipped vehicle, and wherein, with the extender platform in the retracted state, the camera is at a retracted position that is closer to the roof of the equipped vehicle than when the camera is at the extended position, and wherein the camera, when in the extended position, has a field of view that encompasses the equipped vehicle and a region at least partially surrounding the equipped vehicle;
wherein the vehicular vision system, responsive to processing by the image processor of the image data captured by the camera when the extender platform is in the extended state, displays, at a display disposed within the equipped vehicle and viewable by a driver of the equipped vehicle, a bird's-eye view of the equipped vehicle derived from the image data captured by the camera; and
wherein the extender platform transitions between the retracted state and the extended state at least partially based on a determination that the vehicle is parking.

23. The vehicular vision system of claim 22, wherein when the camera is at the extended position, the camera is laterally extended from the extender platform.

24. The vehicular vision system of claim 23, wherein the camera is laterally extended toward a rear of the vehicle.

25. The vehicular vision system of claim 23, wherein the extender platform comprises (i) a vertically oriented arm and (ii) a rearward extending arm, and wherein the camera is disposed at a distal end of the rearward extending arm.

26. The vehicular vision system of claim 22, wherein the extender platform transitions between the retracted state and the extended state at least partially based on a determination that there is at least a threshold amount of clearance above the vehicle.
